(19) United States
(12) Patent Application Publication
(10) Pub. No.: US 2018/0015777 A1
(43) Pub. Date: Jan. 18, 2018

(54) CUSTOMIZABLE GIFT WRAP

(71) Applicants: John P. Sabalaskey, Lake Forest, IL (US); Mary Jo Kadleck, Lake Forest, IL (US)

(72) Inventors: John P. Sabalaskey, Lake Forest, IL (US); Mary Jo Kadleck, Lake Forest, IL (US)

(21) Appl. No.: 15/717,260

(22) Filed: Sep. 27, 2017

Related U.S. Application Data
(62) Division of application No. 14/055,233, filed on Oct. 16, 2013.
Application No. 14/055,233 is a division of application No. 12/909,342, filed on Oct. 21, 2010, now abandoned.
Application No. 12/909,342 is a continuation of application No. 11/196,998, filed on Aug. 4, 2005, now abandoned.

(51) Int. Cl. B44D 2/00; B65D 25/20; G09B 11/00; G06F 17/50

(52) U.S. Cl. CPC B44D 2/002; G06F 17/50; B65D 25/205; G09B 11/00; Y10T 156/10; B65D 2203/00; Y02T 10/82

(57) ABSTRACT

In an embodiment, a gift wrap is provided with a graphic. The user may customize the graphic with designs such as stickers, stencils, and stampers as well as with writing instruments. The user may also customize a design prior to placing the design on the gift wrap. The completed gift wrap can provide an educational experience for the person customizing the gift wrap while providing the recipient with a memorable package that a portion of which may be saved as a keepsake.

### CROSS REFERENCE TO RELATED APPLICATIONS

This is a divisional application of utility application Ser. No. 14/055,233 filed Oct. 16, 2013 entitled “Customizable Gift Wrap” which is a divisional application of utility application Ser. No. 12/909,342 filed Oct. 21, 2010 entitled “Customizable Gift Wrap” which is a continuation of Ser. No. 11/196,998 filed Aug. 4, 2005 entitled “Customizable Gift Wrap”, all of which are incorporated herewith and for which priority is claimed.

### FIELD OF THE INVENTION

The present invention relates to the field of gift wrap, more particularly to the field of customizable gift wrap.

### DESCRIPTION OF RELATED ART

Gift wrap has been used for some time in conjunction with the giving of presents. Gift wrap, such as wrapping paper, decorated bags and boxes, allows the individual giving the gift to ensure the gift remains a surprise until opened. Gift wrap also allows the gift giver to make a statement based on appearance.

While most people enjoy receiving gifts, children are especially enthusiastic about giving and getting gifts. While many younger children want to be involved in wrapping presents using gift wrap that is currently available, they are often discouraged from doing so because their wrapping skills are less advanced. Thus, they tend to feel left out of the family gift giving preparations. Furthermore, some adults also enjoy wrapping presents and would be willing to spend significant time preparing elaborate packages that could be considered works of art.

Children also enjoy working with arts and crafts. For example, children will spend considerable time preparing a project that may be given to a family member or friend. Typically the project involves a number of steps which will result in a completed craft that has an attractive or interesting appearance. The completed craft can then be displayed.

One benefit of allowing children to do crafts is that the process of doing the craft is educational. For example, a part of a craft may include connecting dots in numerical or alphabetical order to form an image and the connecting of the dots allows a child to improve hand-eye coordination, fine motor control as well as teaching or reinforcing the knowledge of numbers and/or letters. Naturally, the amount of educational impact and the difficulty in completing the project depends on the developmental level of the individual doing the craft as well as the complexity of the craft. Certain crafts require adult level developmental skills while other crafts can be accomplished by young children.

Known gift wrap cannot address these issues. Therefore, it would be advantageous to combine some of the education aspects of crafts with a customizable gift wrap.

### BRIEF SUMMARY OF THE INVENTION

In an embodiment of the invention, a gift wrap is provided with a graphic on it. The graphic may include an outline that can be modified as appropriate to create a particular appearance. One or more designs may be placed on the gift wrap and the graphic may be colored with a set of writing instruments. The customized wrap may then be used to encapsulate a present. The customized wrap will allow for a more personalized appearance that can be both fun and educational to prepare.

### BRIEF DESCRIPTION OF THE DRAWINGS

The present invention is illustrated by way of example and not limited in the accompanying figures in which like reference numerals indicate similar elements and in which:

FIG. 1 illustrates an embodiment of a gift wrap in accordance with an aspect of the present invention.

FIG. 2 illustrates an embodiment of a border in accordance with an aspect of the present invention.

FIG. 3 illustrates an embodiment of a message graphic in accordance with an aspect of the present invention.

FIG. 4 illustrates an embodiment of a graphic in accordance with an aspect of the present invention.

FIG. 5 illustrates an embodiment of a design in accordance with an aspect of the present invention.

FIG. 6 illustrates an embodiment of a design in accordance with an aspect of the present invention.

FIG. 7 illustrates an embodiment of a label in accordance with an aspect of the present invention.

FIG. 8 illustrates an embodiment of a graphic in accordance with an aspect of the present invention.

FIG. 9 illustrates an embodiment of a graphic in accordance with an aspect of the present invention.

FIG. 10 illustrates an embodiment of a border in accordance with an aspect of the present invention.

FIG. 11 illustrates an embodiment of a graphic in accordance with an aspect of the present invention.

FIG. 12 illustrates an embodiment of a label in accordance with an aspect of the present invention.

FIG. 13 illustrates an embodiment of a design in accordance with an aspect of the present invention.

FIG. 14 illustrates an alternative embodiment of the design depicted in FIG. 13 in accordance with an aspect of the present invention.

FIG. 15 illustrates a schematic depiction of a kit in accordance with an aspect of the present invention.

FIG. 16 illustrates an embodiment of a message graphic in accordance with an aspect of the present invention.

FIG. 17 illustrates an embodiment of a design in accordance with an aspect of the present invention.

FIG. 18 illustrates elements directed toward a theme in accordance with an aspect of the present invention.

FIG. 19 illustrates an embodiment of a stencil according to an aspect of the present invention.

FIG. 20 illustrates an embodiment of a stamper according to an aspect of the present invention.

### DETAILED DESCRIPTION OF THE INVENTION

While various gift wrap embodiments are possible and will be described below, it may be advantageous to provide a gift wrap directed toward a theme. For example, but without limitation, the gift wrap may be directed towards a calendar theme or an event theme. Examples of calendar themes include, without limitation, birthdays, ethnic holidays, person-specific days (e.g. Mother's Day), religious holidays and national holidays. Event themes include, without limitation, house warming, get well, graduation and marriage. As can be appreciated, some themes could be classified as both a calendar theme and an event theme. In an embodiment a gift wrap could be provided with a neutral theme that could become a calendar or event theme via customization.

It is noted that, as discussed above, gift wrap includes but is not limited to, wrapping paper, bags and boxes. These types of gift wrap can in turn be made of a variety of materials such as, but not limited to, paper, cloth, cardboard, foil, cellophane, plastic, Styrofoam, laminate surfaces and/or any gift wrap materials developed in the future. In addition, each type of gift wrap can be provided in a variety of configurations. For example, wrapping paper can be provided in a number of different forms, ranging from rolls to pre-cut sizes. As another example, a bag can be provided in a small, medium or large size and may include envelopes and/or pockets. Unless otherwise noted this disclosure is not intended to be limiting in this regard.

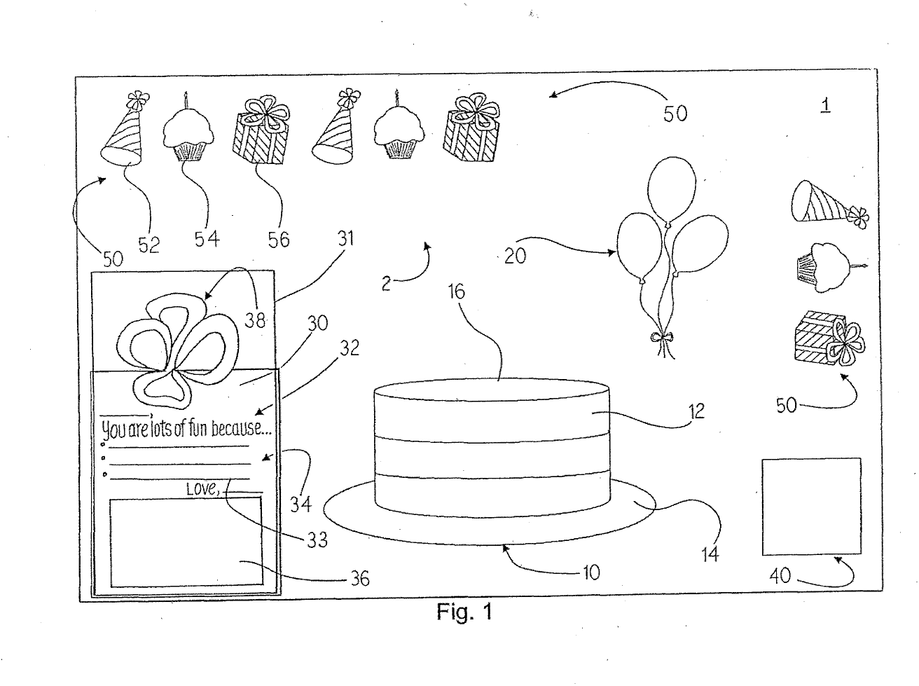

Turning to FIG. 1, an embodiment of gift wrap according to an aspect of the present invention is illustrated. A gift wrap 1, which is depicted as being on a pre-cut size of wrapping paper, includes a background 2. The background 2, which is shown as being solid white for ease of illustration, may be, for example and without limitation, a solid color, a pattern or some type of scene. Positioned on the background 2 is a graphic 10. As depicted, the graphic 10 represents a cake and includes a plurality of layers 12 supported by a base 14. The graphic 10 further includes an upper surface 16. More will be said about this particular graphic below.

It should be noted that the graphic 10 is an outline. In general, there are two subcategories of graphics that may be provided on the gift wrap 1: 1) outlines, and 2) detailed illustrations. The outline provides the general shape but allow significant customization of the graphic 10 by the user. The detailed illustration provides much more detail but still allow the user to customize certain aspects of the graphic 10. Thus, the detailed illustration tends to stimulates logical thought while the outline tends to stimulate creative thought. Naturally, this classification may be more difficult for some graphics 10 but most will clearly fit within one category or the other. In an embodiment, two graphics 10 may be provided on the gift wrap 1 with one graphic being a detailed illustration and one being an outline. Additional graphics 10 may also be provided so as to result in a simple or complex gift wrap as desired.

Mounted on the background 2 near the graphic 10 is a design 20. As depicted, the design 20 represents three balloons. It should be noted that the design 20 could be shaped like a cake and the graphic 10 could be shaped like balloons. Therefore, the design 20 and the graphic 10 may be used somewhat interchangeably. One major difference between the graphic 10 and the design 20 is that the graphic 10 is pre-positioned on the gift wrap 1 while the individual doing the customization places the design 20 on the gift wrap 1. In addition, the graphic 10 requires some customization in order to be considered complete. Additional details regarding the design 20 will be discussed below.

It is noted that as depicted, the graphic 10 is a primary element of the gift wrap 1 while the design 20 is a secondary element. Depending on the configuration of the gift wrap, the design 20 may be the primary element while the graphic 10 is a secondary element. Pre-positioning the primary element (e.g. making the graphic 10 the primary element) may make it easier to for the user to create an overall more aesthetically pleasing gift wrap, especially if the background is a scene. However, allowing the user to position the primary element allows the user to take into account the shape of the item being enclosed in the gift wrap 1. For example, if the user first encloses the gift in the gift wrap and then places the primary element on the gift wrap, the user can better position the primary element in the desired place on the packaged gift. It should be noted that the term user refers to one or more individuals working or assisting in the customization of the gift wrap.

The gift wrap 1 further includes a message graphic 30 located in a blank space 31. The message graphic includes a text portion 32 that provides a focus for the message graphic 30 as well as a signature line 33. The message graphic also includes a writing portion 34, a drawing portion 36 and a decorative portion 38. Additional details regarding the message graphic 30 will addressed below. As can be appreciated, the blank space 31 is covered by the message graphic 30 and therefore is no longer blank. It should be noted that blank space 31 may be a variety of shapes and may be used for orientation purposes as discussed below.

The gift wrap 1 may also include a text block 40. The text block 40 may be as depicted or may be located throughout the gift wrap 1. For example, in a theme directed towards birthdays, a plurality of birthday greetings in different languages may be placed about the gift wrap 1. The text block 40 may also include information about the subject matter of the gift wrap 1. For example, a gift wrap 1 with a dog theme could include blocks of text 40 that provide information about one or more dog breeds. Thus, the text block 40 may provide an additional education aspect and further cognitive development.

As depicted, the gift wrap 1 further includes a border 50 that includes elements 52, 54 and 56. While shown with three elements 52, 54 and 56, the border 50 could include more or less elements as desired and these elements may be repeated along one or more edges of the gift wrap 1; however, for ease of illustration only a partial border is illustrated. In an embodiment the border may include one or more pieces of text. As can be appreciated, on a gift wrap 1 comprising pre-sized wrapping paper the border 50 may run along each edge. In an embodiment the border 50 may be configured as a matte or edging. It is noted that one difference between the border 50 and the background 2 is that the border 50 includes features intended to be customized by the user.

Returning to graphic 10, the user may customize the graphic 10 as desired and in accordance with the user's ability. For example, the user may place designs 20, such as stickers on the graphic 10. In an embodiment, the designs 20 may be stickers that resemble frosting and candles so that the cake may be decorated proportional to the recipient's age. Younger recipients could have a birthday cake with one candle for each year of age while older recipients could simply have sufficient candles to look reasonable. In an embodiment, a separate sticker might be available that allows a particular number of candles, such as 13 or 21 candles, to be placed on the graphic 10. Thus, the candle shaped stickers (not shown) are one possible embodiment of the design 20. In an embodiment, a stamper 80 may be provided to produce a design 20 resembling a flame so as to show the candles as lit.

Generally, it should be noted that while designs such as stickers could be placed on existing gift wrap, existing gift wrap does not include a graphic configured for user customization and users are not given the opportunity to place designs on gift wrap that complement the graphic they are customizing.

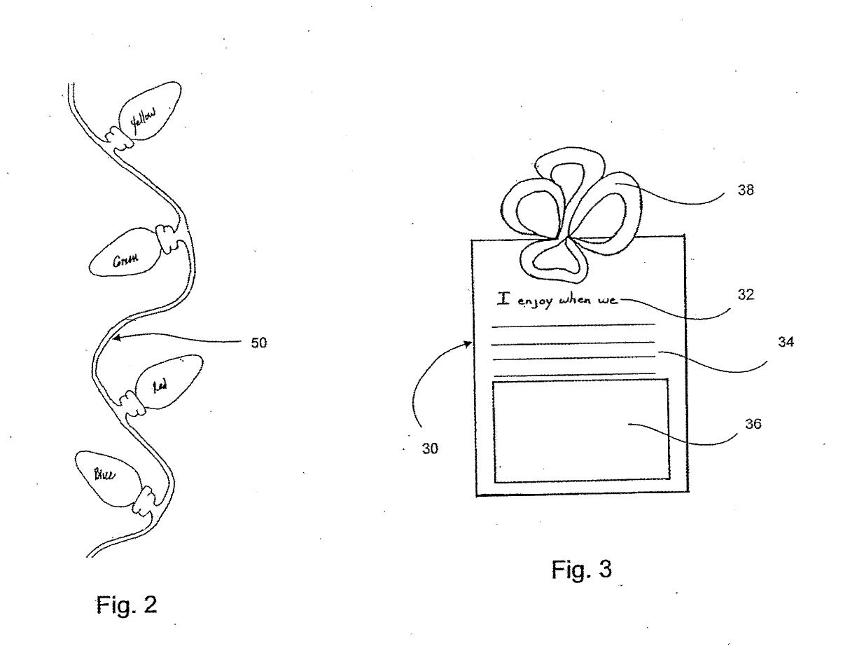

Turning to FIG. 2, an alternative embodiment of a portion of a border 50 is illustrated. As can be appreciated, the border 50 represents a strand of lights. The border 50 may include indicia (such as numbers) in each bulb regarding the appropriate color or the bulbs may be left blank so as to give the user more creative freedom in choosing colors.

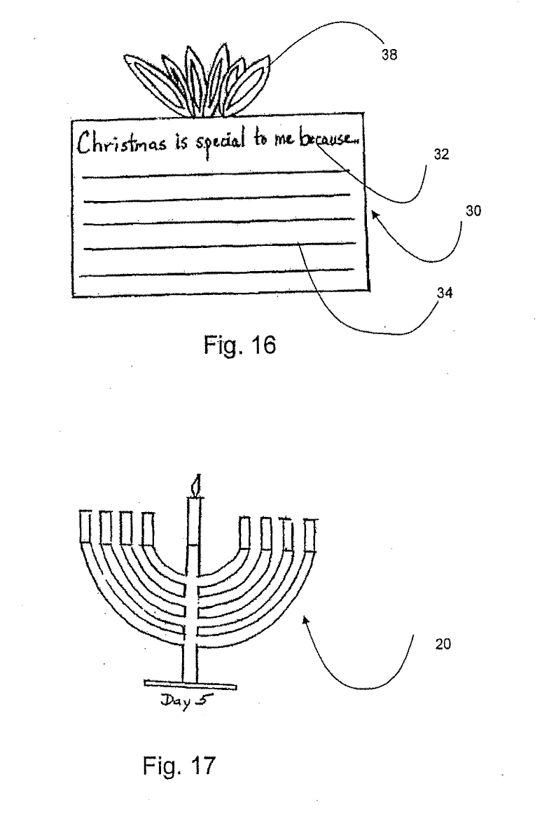

FIG. 3 illustrates an alternative embodiment of the message graphic 30. The message graphic 30 includes the text portion 32 that provides a directional focus for the message graphic 30. The message graphic 30 also includes the writing portion 34 that allows the user to express his or her thoughts. A drawing portion 36 may also be provided to allow the user to make a small illustration to complement the message. In addition, the decorative portion 38 may also be provided. FIG. 16 provides an alternative embodiment of the message graphic 30. While the message graphics 30 in FIG. 3 and FIG. 16 are different, they may be configured to be the same size. While unity of size is not required, several message graphics 30 may be provided, each with a different message and if each message graphic 30 was the same size then the user could place the message graphic 30 of choice in the blank space 31. It is also noted that the blank space 31 could assist in aligning the message graphic 30 with either a graphic 10 or a design 20.

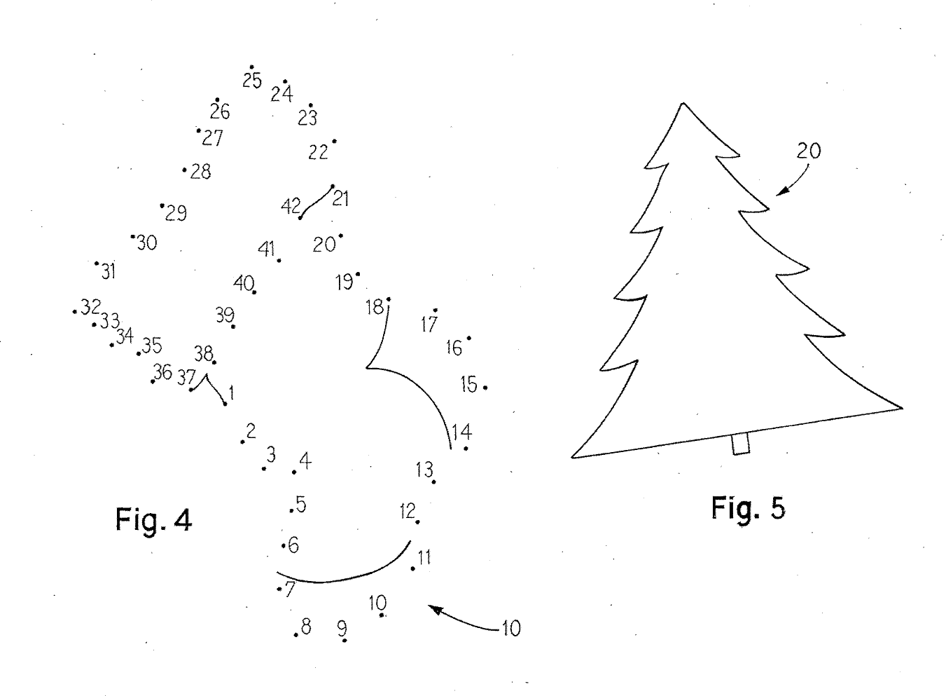

Turning to FIG. 4, a graphic 10 is illustrated in connect-the-dots form. Once the dots are connected in numerical order, a shape is formed that may be decorated. As can be appreciated, the resultant graphic 10 may be either an outline or a detailed illustration. In an alternative embodiment, the graphic 10 could include connect the dots based on alphabetical order. Numerous additional variations in graphics 10 are possible and this disclosure is not intended to be limiting in this respect.

FIG. 5 illustrates a design 20 that is an outline resembling a Christmas tree. The Christmas tree shaped design 20 may be customized with other designs 20 such as stickers resembling Christmas tree bulbs (not shown) or stampers or stencils that can be placed on the Christmas tree design 20 either before or after the design 20 is mounted to the gift wrap 1 so as to decorate the Christmas tree design 20. Thus, as can be appreciated, one design 20 may be used to decorate another design 20. Similarly, the graphic 10 may be decorated and customized with designs 20. Thus, designs and graphics may have similar forms. For example, a design 20 could also include a section that includes connect-the-dots, color by numbers, etc. Thus, like the graphic 10, the design 20 may be provided in a wide variety of configurations.

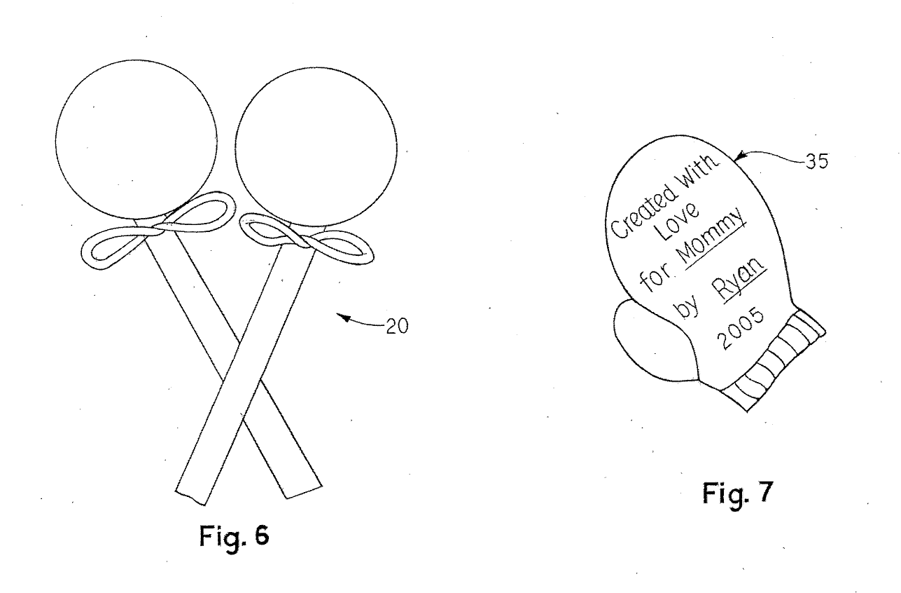

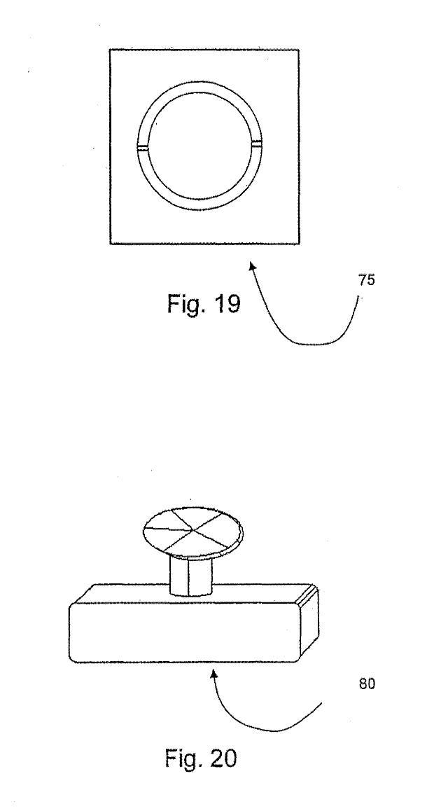

Turning to FIG. 6, an embodiment of a design 20 is depicted. In an embodiment, the design 20 will be produced by a stencil 75 (FIG. 19). Thus, the user will place the stencil 75 on the gift wrap and shape the design 20. The user can then further customize the design 20 by, for example, adding color or additional details. Naturally, this type of activity is somewhat more difficult then placing a sticker on the gift wrap 1 and therefore may be more suitable for users with more advanced fine motor control skills.

A design may also be provided by a stamper 80 (FIG. 20). Stampers exist in various configurations and, as is known, stampers can be used with various colors of ink and additives to produce intricate and varied designs.

Looking at FIG. 7, a label 35 is illustrated. As can be appreciated, younger users may have trouble articulating and writing their thoughts in a manner sufficient to complete the message graphic 30 depicted in FIG. 1, therefore the use of the label 35 allows the user to personalize the gift wrap with the recipient's name and the user's name. In an alternative embodiment, an adult could help a younger child write in the thoughts verbalized by the child. It should be noted that the label 35 may be preprinted on the gift wrap 1.

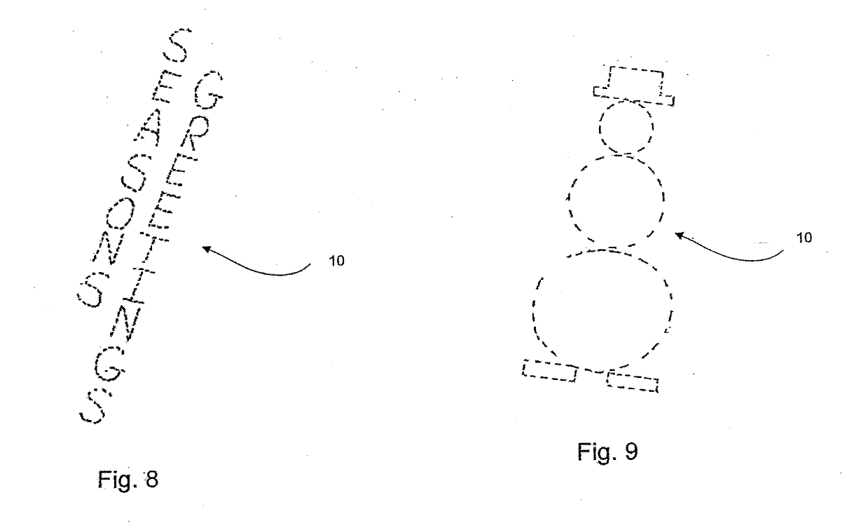

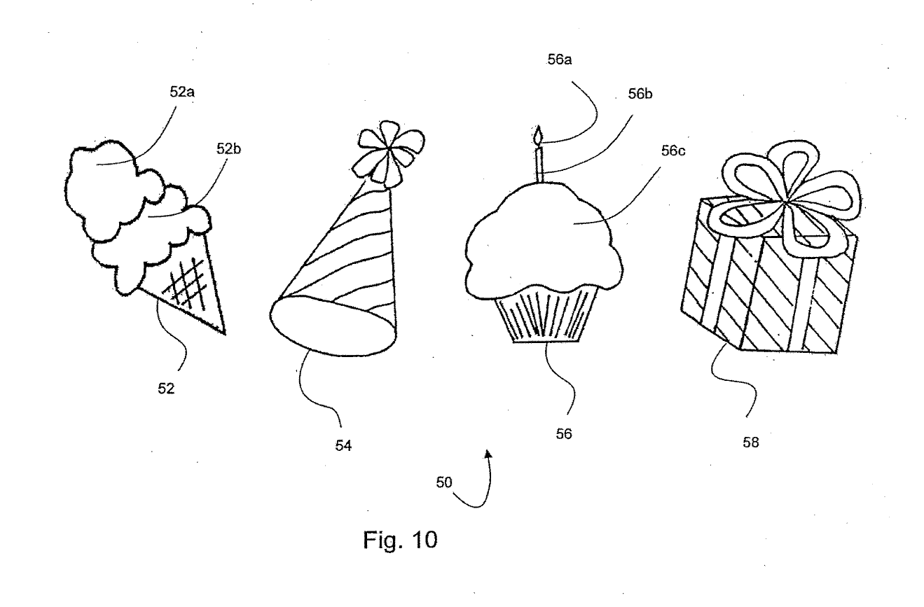

FIGS. 8 and 9 illustrate two similar examples of graphics 10. FIG. 8 illustrates a broken line depiction of the phrase “seasons greetings.” The user may draw/trace over the broken line depiction, thereby developing fine motor skills and learning words and letters. FIG. 9 illustrates a broken line depiction of a snowman. The user may place designs 20 (e.g. stickers or stampers) in the corresponding places indicated by the broken lines to provide a completed snowman and to learn shapes and sizes.

FIG. 10 illustrates a portion of a border 50. The border includes elements 52, 54, 56 and 58. In an embodiment these elements may be repeated along the length of the border 50, which may extend along the edge of the gift wrap 1 (FIG. 1). As depicted, element 52 includes sub-element 52a and sub-element 52b that are configured for customization (e.g. are provided blank). Similarly, element 56 includes sub-elements 56a, 56b and 56c that may be customized. The provision of sub-elements for customization allows the user to more quickly customize the entire border 50 without requiring extensive time. This also allows the border 50 to contain a pattern or sequence that requires completion and/or correction so as to provide additional cognitive development. For example a repeating pattern could be missing a color or the color of one of the sub-elements could be inconsistent with the rest of the pattern. Providing for customization of sub-elements can be important for larger packages that would otherwise take an excessive amount of time to customize. Of course, similar depictions could be part of the background and not provide for user customization at all.

Turning to FIG. 11, another embodiment of a graphic 10 is provided. As can be appreciated, the banner depicted by the graphic 10 could also be provided by a design 20. However, users may find it easier to work with a graphic 10 as the size increases because it may be difficult to properly position a design 20 if the design 20 is overly large. It should be noted that, depending on the overall look and complexity of the gift wrap 1, the user may want to first customize the gift wrap 1 and then enclose the gift with the gift wrap 1. In an embodiment, the gift wrap 1 may be sectioned before being used to enclose a plurality of gifts.

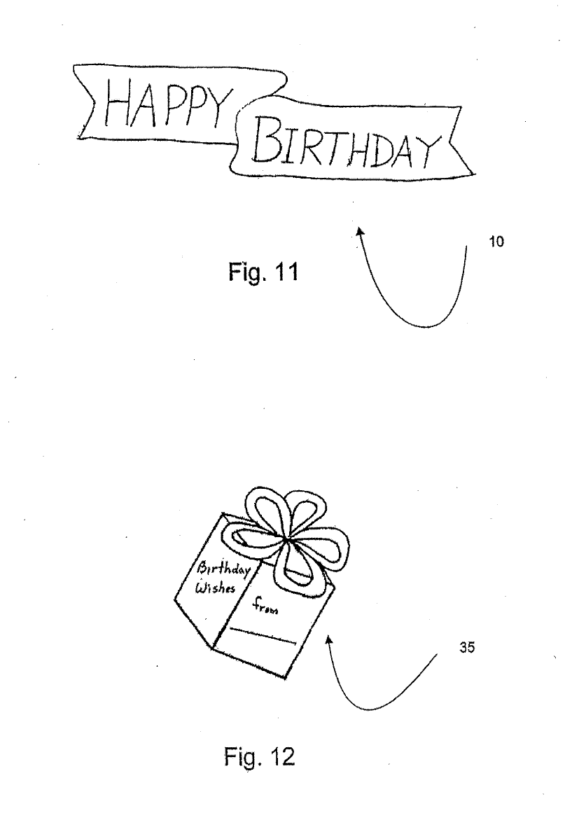

FIG. 12 illustrates a simple label 35. As can be appreciated, for very young users the concept of a name is unhelpful. However, even very young children can make a mark on the label 35.

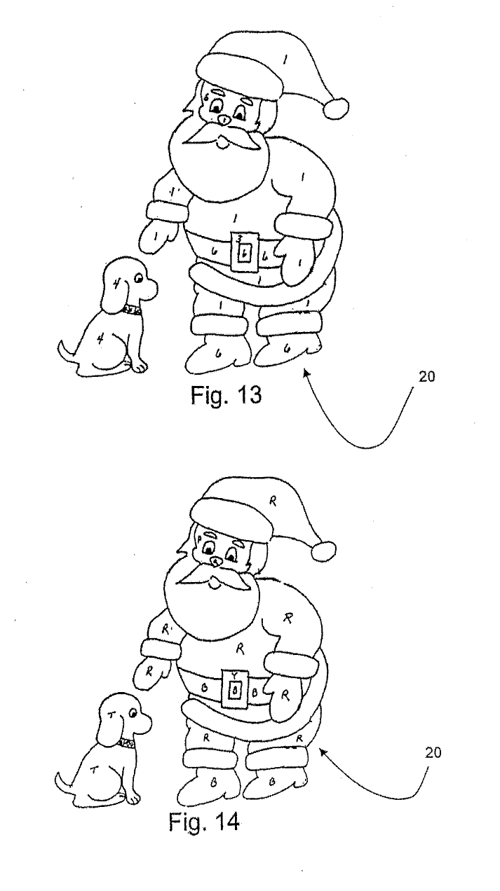

Turning to FIGS. 13 and 14, two variations of a design 20 are illustrated. FIG. 13 illustrates a design 20 that is configured to be colored according to numbers. In an embodiment, the design 20 may be painted, however, colored writing instruments could also be used. Thus, as used herein, to “color” something means to cause an area to change color. This may be provided through the process of, but is not limited to, adding color via some instrument, such as but without limitation, a paint brush, a crayon, a pencil or marker. FIG. 14 is also configured to be colored but according to the first letter of the color. Thus, B could stand for black, R for red, etc. As can be appreciated, the design 20 can be as intricate as desired with the realization that increased amounts of skill are required as the level of intricacy increases. It is noted that the design 20 could also be provided as a graphic 10.

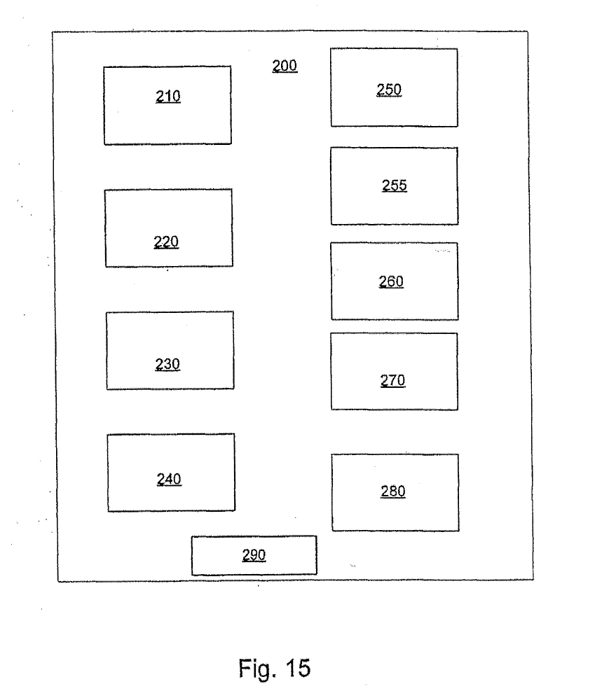

Turning now to FIG. 15, a gift kit 200 is illustrated in schematic fashion. The gift kit 200 may include a gift wrap 210 that includes a background 2 and may also include a graphic 10 (FIG. 1). The gift kit 200 may further include a writing instrument set 220, a sticker set 230, a paint set 240, a stencil set 250, a stamper set 255, a design 260, a border 270, and a craft tool kit 280. In addition, an instruction 290 may also be provided as an aid to customizing the gift wrap 210. Depending on the purpose of the gift kit 200, one or more of these items may be omitted and other items may be added.

The gift wrap 210 is configured to be customized, however it should be noted that the gift wrap 210 should be configured with respect to the items provided in the kit for the purpose of customization. For example, if the gift kit 200 includes the paint set 240 (which may include one or more paints and may also include a brush) then it would be advantageous to ensure the gift wrap 210 will allow the user to apply the paint without damaging the gift enclosed in the gift wrap 210. This may include providing a section of the gift wrap 210 that is impervious to paint but still allows the user to readily paint on the section. In this regard it should be noted that gift wrap 210 in the form of a box or bag may allow for a wider variety of customization and may be more readily prepared in advance.

As noted above, the gift kit 200 may include one or more sets. As used herein, the term set means one or more. Thus, for example, the writing instrument set may be one or more writing instruments. Writing instruments include all writing utensils such as pens, pencils, markers, crayons, chalk and the like. In addition, the writing instrument set 220 may contain a plurality of different colors. In an embodiment, the writing instrument set may include a plurality of markers configured to only make a color on a particular type of surface with the correct chemical make-up. In an alternative embodiment the writing instrument set may include one marker configured to not color normal surfaces but to cause an area with the appropriate chemical make-up to form a pattern that includes one or more colors.

The sticker set 230 may include one or more stickers that may be positioned on the gift wrap 210 or on other designs. The stencil set 250 includes one or more stencils for use in customizing the gift wrap 210 or a design 260 that is part of the sticker set 230. The stamper set 255 includes one or more stampers 80 (FIG. 20) and may include inks of various colors configured to be used with the stampers 80. The design 260 is configured to be placed on the gift wrap 210. The design 260 may be mounted on the gift wrap 210 via adhesive or tape or other mounting methods. In an embodiment, the design 260 may have an adhesive backing that is protected by a covering. After removing the protective covering, the design 260 can adhere to the gift wrap. If so configured, the design 260 will be relatively easily to place on the gift wrap 210, either before or after the gift wrap 210 is used to enclose the gift. Thus, in an embodiment, the sticker set 230 and the design 260 may be the same thing. In an alternative embodiment, the sticker set 230 will include additional designs (e.g. FIGS. 13-14).

To aid in placement of the design 260, the gift wrap 210 may include the blank area 31 (FIG. 1) that is helpful in locating the design relative to other elements on the gift wrap 210. In an embodiment, the gift wrap 210 may include a number of blank areas 31, each labeled numerically. Various designs 20 and/or message graphics 50 may be provided with corresponding numbers so that they can be positioned accordingly.

A border 270 may also be provided. However, as discussed above, the border 270 may be pre-positioned on the gift wrap 210. The advantage of providing a separate border 270 is that the border 270 may be positioned after the package is wrapped so as to ensure the border 270 is located in the appropriate location.

As mentioned above, the craft tool kit 280 may also be included and the craft tool kit 280 may include things such as tape, glue, scissors, stampers, stamper ink, sparkles and the like. In an embodiment, the craft tool kit 280 may include any specialty items helpful in customizing the gift wrap according to the instructions 290. In an alternative embodiment, the craft tool kit 280 may be complete and include all the items needed to customize the gift wrap 210 according to the instructions 290. The advantage of including all the needed items in the craft tool kit 280 is that the gift kit 200 may be all-inclusive. The disadvantage is that the cost of the kit 200 will obviously rise as additional items are added. Furthermore, many individuals have some of the items contained in the craft tool kit 280, thus making those items redundant. However, for certain situations a complete craft tool kit 280 will be desirable and provide a one-stop shopping experience that is sometimes desired.

The kit may also include the instructions 290. While the instructions 290 may not be needed for a gift wrap 210 that is less intricate and more suitable for younger users, instructions 290 will likely benefit users customizing more intricate gift wrap 210. In an embodiment, the gift kit 200 may consist of the gift wrap 210 and instructions 290. Such a gift kit 200 may help reduce the cost and may be more desirable to individuals that have all the materials needed to customize the gift wrap 210 but would like the instructions.

Advances in technology allow individuals to perform many operations automatically. Therefore, the present invention may be utilized in a more automated process such as via a software application over a network to generate customized gift wrap. It could also be performed in a kiosk such as the stand-alone kiosks typically found in shopping malls. An advantage of doing so is that it is possible to provide a more consistent looking product if the entire gift wrap product is produced through an automated process. In an embodiment, the kiosk may be used to create a user selected gift wrap that may contain, for example but without limitation, a user selected graphic, background and/or border in an arrangement selected by the user and then the gift wrap may be customized as appropriate. The kiosk may also allow the user to select particular designs for use in customizing the gift wrap. If the younger children can play a significant role in customizing the gift wrap itself then their cognitive and fine motor skills stage of development can become an asset in the preparation of the gift wrap. Thus, the wrapping of the present can provide a rewarding and educational experience for the children and their families. In addition, when done manually the resultant gift wrap will tend to be unique because of variations in the process of customizing the gift wrap.

FIG. 16 provides a further illustration of an embodiment of a message graphic 30. As can be appreciated, the message graphic includes the text portion 32, the writing portion 34 and the decorative portion 38. In an embodiment the message graphic may come pre-positioned on the gift wrap. However, such an embodiment is most effective when the gift wrap is provided in a particular size, such as pre-sized wrapping paper or a bag or box.

FIG. 17 illustrates a design 20. As can be appreciated, certain holidays may consist of a number of days. In such a situation, a gift wrap 1 may be provided that is suitable for all or a number of the days and a plurality of designs 20 may be provided, where one of the plurality of designs 20 is appropriate for the each day in the series.

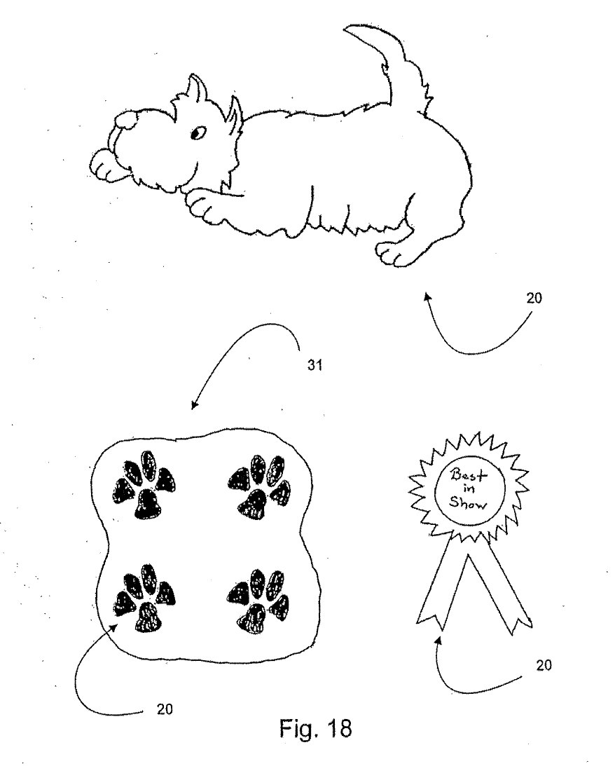

Turning to FIG. 18, several components are illustrated together. As is known, many individuals take great pride in their pets and, for example, the showing and breeding of dogs is a significant business. Therefore, some individuals would enjoy customizing the gift wrap 1 based on their pet. Accordingly, designs 20 may be provided that relate to a general or specific pet theme. For example, a design 20 could be provided for specific animal breeds. In addition, the blank space 31 could be configured to accept a design 20 in the shape of pet prints, such as paw prints for a dog. To generate the pet prints from the user's pet, a safe ink or a substrate with an ink provided on one side may be used. In an alternative embodiment, the design 20 could be a sticker, a stamper or a stencil configured to resemble a pet print.

It should be noted that for younger individuals the process of customizing the gift wrap is both educational and enjoyable. For older individuals, customized gift wrap is desirable but the time and/or skill required to create a suitable gift wrap may be more than is available. For these individuals, a more automated process such as can be accomplished by computer software over the Internet may be more desirable. The individuals may still customize the gift wrap to a greater extent than is currently available but can be assured that the final outcome looks professional. For example, in an embodiment the gift wrap might have a glossy finish such as is common with conventional gift wrap while still including the user's customization. In an embodiment the customized gift wrap could be shipped directly to the individual's house. In another embodiment the customized gift wrap could be obtained from a kiosk that included the computer software for generating the customized gift wrap. In another embodiment, customized gift wrap could be generated via an Internet connection and a merchant could use the customized gift wrap to package a gift and then the gift could be sent to the intended recipient directly from the merchant. In an alternative embodiment, the user could select and/or create a gift wrap over the Internet as discussed above with regard to the kiosk.

It is also noted that the gift wrap 1, when customized, may be valuable to the recipient as a keepsake. Therefore, in an embodiment the gift wrap 1 may be configured so that a portion of the gift wrap 1 may be removed from the package without being damaged so it may be saved for archival purposes. For example, gift wrap with a removable customizable section could provide this type of feature.

While additional variations exist, in an embodiment the gift wrap 1 may comprise wrapping paper with a glossy finish and at least one graphic requiring user customization. Such a gift wrap would be similar to typical wrapping paper in finish but could be configured so as to be incomplete as provided so that some work would be required by the user to “finish” the wrapping paper wrap. This would provide for some cognitive and/or motor skill development while ensuring a professional finish. In an embodiment, the wrapping paper would be pre-cut so as to make it easier to position the graphic as desired. In an embodiment, the graphic could include a section requiring coloring or the connecting of dots in a predetermined order.

The present invention has been described in terms of preferred and exemplary embodiments thereof. Numerous other embodiments, modifications and variations within the scope and spirit of the appended claims will occur to persons of ordinary skill in the art from a review of this disclosure.

What is claimed is:

1. An educational craft kit for children of a select developmental level, said kit in the form of an assembly of multiple elements which may be variously combined to create a customized gift wrap consisting of a single visual theme selected from the group consisting of a birthday, a holiday, a calendar date, an event, a religious holiday, and a pet, said multiple elements characterized by a said select developmental level of motor skills, creativity, logic, cognition and dexterity, said multiple elements consisting of in combination:
(a) a visual printed wrapping sheet having a background surface of a single visual color, said wrapping sheet including a circumferential edge defining said background surface, said wrapping sheet further consisting of a plurality of separate visual graphic images printed on said background surface, said visual images selected from the group consisting of a numeric symbol, an alphabetic symbol, a line design, a border printed around at least a section of the background surface edge, a message graphic, an object graphic, a partial graphic image design, a label, a partial message graphic, a numeric sequence, an alphabet sequence, a word, a greeting, a character illustration, an animal illustration, a person illustration, a costume illustration, a greeting single message, and combinations thereof, each said visual image selected to represent the theme and in accord with the developmental level of skills;
(b) said kit further consisting of a plurality of adhereable image design sources capable of placement on and adherence to the background surface, said image design sources selected from the group consisting of message stickers, image stickers, colored stickers, image design labels, stencils, and optionally stampers to provide images onto said wrapping paper surface by placement on selected blank areas, alternately to said visual graphic images printed on said wrapping paper surface and to applied image design sources, said image design sources variously applicable by a said child to express a said theme in accord with a said developmental level of a said child;
each said select visual graphic image and applied image design source in combination consisting of a composite image of said single visual theme in accord with said developmental level of creativity, logic, cognition and dexterity; and
(c) a collection of writing instruments capable of providing a visual image on said background surface, said visual graphic images, said image design sources and said blank spaces, said writing instruments selected from the group consisting of crayons, ink pens, markers, pencils and brushes.

2. The kit of claim 1 wherein the border consists of a visual circumferential design image of said single visual theme and said common developmental level.

3. The kit of claim 2 wherein the border is an incomplete visual image.

4. The kit of claim 1 wherein the separate visual images on the wrapping surface are a combination of linear designs and symbols.

5. A kit for creation by children at a prescribed developmental level of a customized thematic gift wrap for a gift to a selected recipient, said gift wrap consisting of a single visual theme selected from the group consisting of a birthday, a holiday, a calendar date, an occasion and a pet, said kit further consisting of a set of multiple elements characterized by said prescribed developmental level of children for development of skills from the set consisting of creativity, logic, cognition and dexterity, said kit elements consisting essentially of in combination:
(a) a printed wrapping sheet having a border and background surface of a single visual color, said wrapping sheet including an optional border visual image; said wrapping sheet further consisting of at least one visual graphic image on said background surface, said at least one visual graphic image printed on said background surface at a first distinct location area within said border; said at least one visual graphic image selected from the group consisting of an outline and an incomplete illustration, said at least one visual graphic image located on said background surface at a second surface placement positioned as a primary visual element on the background surface and to simultaneously accommodate the shape of the gift intended to be wrapped by the wrapping sheet, said at least one visual graphic image consisting of an incomplete image characterized by a said single visual theme and a said common developmental level of motor skills, creativity, logic, cognition and dexterity skills; said wrapping sheet further consisting of a plurality of additional discrete surface blank areas for receipt of a visual design image;
(b) said kit set further consisting of a sticker set, a stencil set, an optional stamper set and an optional ink substrate material image source, each said sticker set, stencil set, optional stamper set and said optional ink substrate material image source consisting of visual design image sources for application to selected said blank areas, to said at least said one visual graphic image on said sheet background surface and to a said visual design image placed by a said child on said wrapping sheet;
(c) said kit set further consisting of a writing instrument set capable of placement of a visual design image to said at least one visual graphic image, said blank spaces, along said border on said wrapping sheet and to said image design sources;
(d) said visual design image sources and said at least one visual graphic image each consisting of images of said single visual theme and characterized by said prescribed common developmental level of motor skills, creativity, logic, cognition and dexterity skills, to provide in combination multiple distinct images resulting from application of said visual images from the design image sources onto the at least one visual graphic image and said blank spaces on the background surface of the wrapping sheet; and
(e) said writing instrument set capable of providing a visual image on said background surface, images at said border, said visual graphic images and on said blank spaces to provide multiple distinctive combinations in accord with the single visual common theme.

6. The kit set of claim 5 including written instructions for use of the kit set by said developmental level of children.
